(19) United States
(12) Patent Application Publication
(10) Pub. No.: US 2013/0242489 A1
(43) Pub. Date: Sep. 19, 2013

(54) PROTECTION OF DEVICES CONNECTED TO COMPUTER ACCESS PORTS

(71) Applicant: Madeleine Davidson, Pepper Pike, OH (US)

(72) Inventor: Madeleine Davidson, Pepper Pike, OH (US)

(21) Appl. No.: 13/754,657

(22) Filed: Jan. 30, 2013

Related U.S. Application Data
(60) Provisional application No. 61/593,156, filed on Jan. 31, 2012.

(51) Int. Cl. G06F 1/16

(52) U.S. Cl. CPC G06F 1/16
USPC 361/679.02

(57) ABSTRACT

The invention is an apparatus and method for protecting a plug-in device that can be connected to an access port in a computer housing. The apparatus includes a guard that includes a bumper adapted to be positioned in proximity to an access port. A connection between the bumper and the housing causes the bumper to be spaced a desired distance away from the housing. The connection can be in the form of legs that in use squeeze the outside of the housing or which expand outwardly against opposing portions of the housing. The bumper also can be mounted to retract into the housing or extend outwardly of the housing. The bumper preferably is in the form of a frame having an opening therethrough that permits plug-in devices to be inserted into or removed from the access ports through the opening.

### REFERENCE TO RELATED APPLICATION

The present application claims priority from U.S. provisional application Ser. No. 61/593,156, filed Jan. 31, 2012 by Madeleine Davidson, entitled “Protection of Devices Connected to Computer Access Ports,” the disclosure of which is incorporated in its entirety by reference herein.

### BACKGROUND OF THE INVENTION

1. Field of the Invention

The invention relates to the protection of plug-in devices connected to computer access ports and, more specifically, to a guard that can be attached to or included as part of a computer housing for protecting plug-in devices connected to the computer's access ports.

2. Description of the Prior Art

Computers typically have a variety of access ports that enable accessories such as printers, keyboards, and removable storage devices (e.g., flash drives) to be connected and disconnected from the computer. In the particular case of removable data storage devices, uniform serial bus (USB) ports commonly are used to connect such devices to the computer. For convenience, all such devices that can be connected or disconnected from a computer by being inserted into or removed from an access port such as a USB port will be referred to herein as “plug-in devices.” On a desktop computer housing, USB ports often are provided on both the front and rear walls of the housing for convenient access by the user. On a laptop computer, USB ports often are provided on the side edges or walls of the computer housing.

Although USB ports permit plug-in devices to be connected and disconnected from the computer conveniently, a problem exists concerning protection of the devices while they are connected to the computer. For instance, flash drives usually are small, rigid devices that typically project from the computer housing when they are connected to a USB port, since USB ports are usually flush with the computer housing. As such, when these plug-in devices are connected to the USB port(s), they are vulnerable to damage by being inadvertently bumped or hit. As a consequence, any movement of the flash drive relative to the USB port other than “straight in, straight out” is likely to cause damage to the flash drive, the USB port, or both.

Prior efforts to protect flash drives are known, including U.S. Pat. No. 7,076,581 to Cheng, which teaches a deep slot provided in a computer housing to receive a flash drive. A USB port is located at the bottom of the slot. Thus, the flash drive being substantially recessed during use, will provide protection from damage. Unfortunately, there are limits for the device since it will only accommodate flash drives having a cross-sectional configuration that can be received by the slot. Large or unusually shaped devices cannot be used. In addition, the use of a deep slot reduces the internal volume of the housing that otherwise would be available for computer components, thereby making it impractical for laptops and other computers that have internal space limitations. Further, it may be difficult for some users to grasp the flash drive to remove it from the slot.

Other devices are known for protecting other electronic components for computers or computer housings, but these prior devices are not suitable for protecting plug-in devices. Examples of other devices include U.S. Pat. No. 4,273,400; U.S. Pat. No. 4,471,409; U.S. Pat. No. 4,928,820; U.S. Pat. No. 6,137,689; and U.S. Pat. No. 6,498,731. For example, the '820 patent discloses a snap-on bumper 10 that fits over an integrated circuit board. The bumper 10 has end portions 11, 12 that fit over the ends of the board. The end portions 11, 12 are interconnected by thin intermediate struts 13, 14 that form an opening that can receive a center pad 25. While the device in question may be able to protect an integrated circuit board, there is no suggestion or teaching that these devices have applicability to computer housings or plug-in devices that may be used in conjunction therewith.

Because of the drawbacks of the prior art, there remains a need for a technique to protect a plug-in device from damage while it is connected to a computer's access port. Any such technique should permit plug-in devices of virtually any size or shape to be used with the computer, and it should permit the devices to be connected and removed easily. Moreover, any such technique should not reduce the internal volume of the computer housing or should reduce it to the least extent possible.

### SUMMARY OF THE INVENTION

The present invention provides a new and improved guard for protection of devices, such as plug-in devices or storage devices, which are connected to and protrude from computer access ports and, more specifically, to a guard that is adapted to attach to or is included as part of a computer housing for protecting devices connected to the computer's access ports.

In accordance with the present invention, the guard comprises a bumper adapted to be positioned about an access port, and a connection between the bumper and the computer housing. The connection causes the bumper to be spaced a distance away from the housing. In a preferred embodiment, the bumper may have an opening therethrough, analogous to a frame structure. The opening of the frame can be adapted to be positioned about an access port so that a user may easily access, insert, or remove a plug-in device. The frame can include telescoping members that contain springs that cause the telescoping members to be biased in a desired direction.

In a preferred embodiment, the connection between the bumper and the computer housing may be a set of first and second movable arms connected to the frame and configured to extend over the sides of a computer housing. The arms can be retained in position against the outside of the housing via spring tension that tends to press the arms toward each other, against the outside of the housing. In another embodiment, the arms can be retained in position against inside portions of the housing via spring tension that tends to press the arms away from each other, against the inside portions of the housing. In yet another embodiment, the first and second arms are fitted into openings included as part of a computer housing. In that case, the arms can retract inside the computer housing and can retain the bumper against a wall of the housing; the arms can be extended to position the bumper away from the wall of the housing.

The first and second arms engage the computer housing to keep the frame a desired distance away from face of the housing. Thus, the frame protects the access ports and any devices connected to said ports. The spring-biased frame and arms allow the guard to fit various sizes and types of computer housings. Additionally, the opening in the frame allows for easy access to the ports and accommodates various plug-in devices.

The foregoing and other features and advantages of the invention will be apparent from the description that follows, taken in conjunction with the accompanying drawings.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a perspective view of a guard according to the present invention;

FIG. 2 is a top plan view of the guard of FIG. 1 connected to a computer housing, showing the internal details of a spring unit inside a frame of the guard;

FIG. 3 is a front view of the guard of FIG. 1, showing the internal spring units;

FIG. 4 is a cross-sectional view of the guard of FIG. 1 taken along line 4-4 of FIG. 3;

FIG. 5 is a perspective view of the guard of FIG. 1, where the guard is contracted and the arms are folded inwardly to a stowed position;

FIG. 6 is a perspective view of a guard according to another embodiment of the present invention;

FIG. 7 is a top plan view of the guard of FIG. 6 connected to a computer housing, showing the internal details of a spring unit inside a frame of the guard;

FIG. 8 is a front view of the guard of FIG. 6, showing the internal spring units;

FIG. 9 is a cross-sectional view of the guard of FIG. 6, taken along line 9-9 of FIG. 8;

FIG. 10 is a perspective view of the guard of FIG. 6, where the guard is expanded and the arms are folded outwardly;

FIG. 11 is a perspective view of a guard according to another embodiment of the present invention;

FIG. 12 is a top plan view of the guard of FIG. 11 connected to a computer housing; and

FIG. 13 is a front view of the guard of FIG. 11 connected to a computer housing.

### DESCRIPTION OF THE PREFERRED EMBODIMENT

The current invention provides protection of devices, which are connected to and protrude from computer access ports on a computer housing, by absorbing shock or impeding contact to the device. Although the following description is in terms of protecting plug-in devices, the current invention could be used to protect other devices connected to the computer housing. The computer housing illustrated herein is used with a so-called desktop computer, although the computer could be of any other type such as a laptop computer.

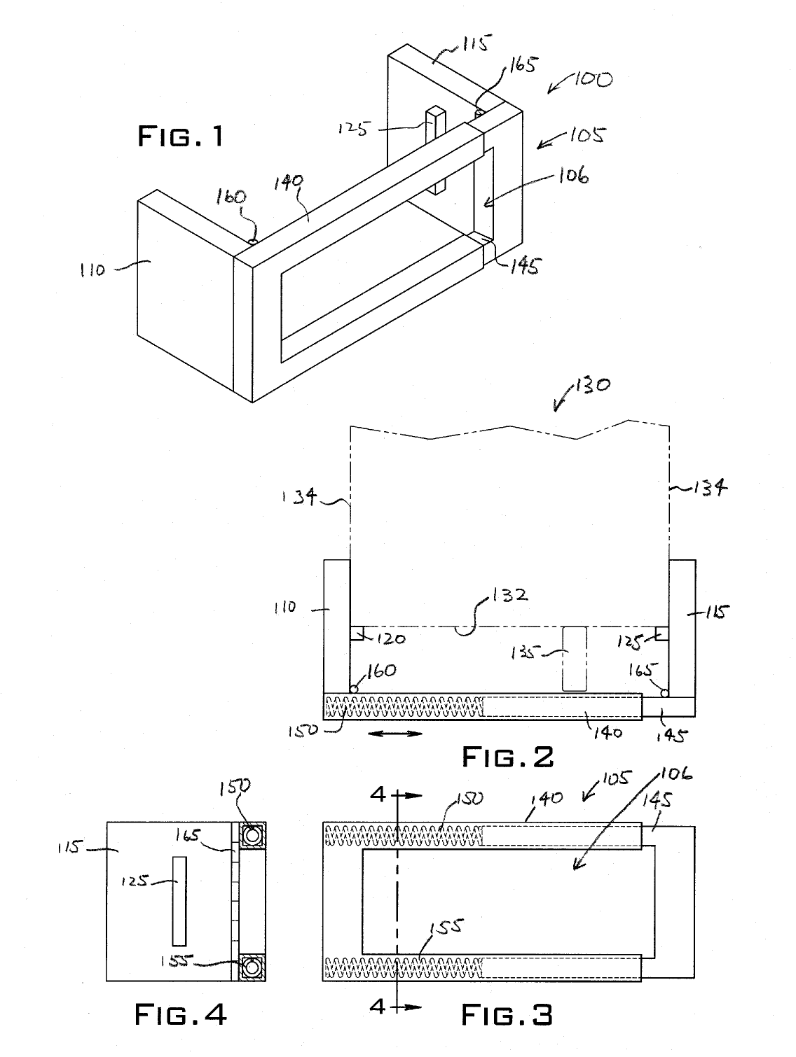

Referring to FIG. 1, a guard 100 according to the present invention is shown. Although the term guard is used herein to describe the invention, the guard may also be referred to as a protection device, a shield or any like device that engages a computer housing to provide protection by absorbing shock or impeding contact to a plug-in device.

Generally, the guard comprises a bumper, adapted to be positioned about or in proximity to an access port, and a connection between the bumper and the computer housing. It is to be appreciated that the guard may be one continuous piece or may comprise multiple pieces. The guard may be made of a plastic or rubber or any other type of suitable material. The bumper is a horizontal piece that provides protection to a plug-in device connected to and protruding from the access port. The connection engages the housing and causes the bumper to be spaced a desired distance away from the wall or face of the housing that contains one or more access ports.

As will be described in a preferred embodiment, the bumper may be a frame-like structure, having an opening therethrough, and the connection may be movable arms attached to the frame-like structure. The size and shape of the opening can be selected to surround a single access port or a plurality of access ports, whether arranged in a single row, multiple rows, or in an array.

Referring to FIGS. 1-5, the guard 100 comprises a frame 105, having an opening 106 therethrough, with movable first and second arms 110, 115, connected to opposite ends of the frame for engaging a computer housing 130. The computer housing 130 has a wall or face 132 that contains one or more access ports, such as a USB port, into which plug-in devices such as flash drives can be inserted. The computer housing 130 has side walls 134.

The first arm 110 may include a first projecting portion, or stopper 120, and the second arm 115 may include a projecting portion, or second stopper 125. The stoppers 120, 125 are located on the interior side of the arms 110, 115 to engage the front edges or wall 132 of the computer housing 130 and ensure that the frame 105 is spaced a desired distance away from a computer housing 130. Additionally, the first and second arms 110, 115 may be operably connected to the frame 105, for example, via hinges 160, 165. The location of the hinges 160, 165 means that the arms 110, 115 can be folded inwardly but not outwardly beyond a position that is perpendicular to the frame 105.

It is to be appreciated that other types of connections may be used to attach the arms 110, 115 to the frame 105 and to cause the arms 110, 115 to be movable. Additionally, the frame 105 and/or arms 110, 115 may be made of one continuous piece of flexible material that allows for movement of the arms 110, 115 over the computer housing 130.

Referring particularly to FIG. 2, guard 100 is connected to the computer housing 130. The computer housing 130 may be any type of enclosure, case or chassis that contains computer components. Plug-in device 135 is connected to computer housing 130 via an access port. The guard 100 further comprises first and second tubular members 140, 145. The first tubular member 140 includes two internal spring units 150, 155 both shown in a detailed front view of the guard in FIG. 3. The second tubular member 145 is telescopically received into the first tubular member 140. When the first and second tubular members 140, 145, are fitted together, the rectangular opening 106 is formed. FIG. 4, a cross-sectional view of the guard along line 4 of FIG. 3, shows the second arm 115, stopper 125, hinge 165 and spring units 150, 155. The springs 150, 155 are connected to the ends of the second tubular member 145 and serve to bias the second tubular member 145 to the left as viewed in FIG. 3, i.e., to a position where the arms 110, 115 are closest to each other.

Retracting the first and second tubular members 140, 145 in opposite directions causes the first and second arms 110, 115 to move apart from each other against the bias of the springs 150, 155. Thus, as shown in FIG. 2, when guard 100 is positioned over an access port on computer housing 130, the first and second tubular members 140, 145 may be retracted to extend the first and second arms 110, 115, around the outer edges or sides 134 of computer housing 130. Releasing the first and second tubular members 140, 145, causes the first and second arms 110, 115, to bear against the outside walls 134 of the computer housing 130. The guard 100 is retained in place on the housing 130 via spring tension created by the force applied by spring units 150, 155.

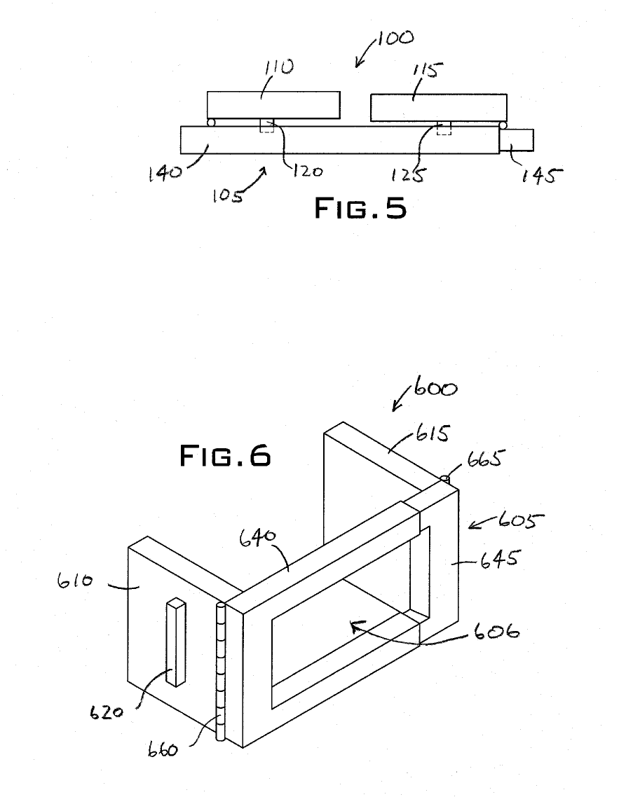

The stoppers 120, 125 engage the outside edges of front wall 132 of the computer housing 130 to ensure the frame 105 is spaced a desired distance away from the wall or face 132 of computer housing 130. The spacing of the frame 105, coupled with the size of the opening 106, allows easy access to various types and sizes of plug-in devices and protects plug-in device 135 from being inadvertently bumped or hit. The guard 100 is also collapsible, as shown in FIG. 5, for transport or storage. This is facilitated by folding the first and second arms 110, 115 inwardly against the frame 105.

Referring to FIGS. 6-10, a perspective view of another embodiment of the present invention is shown and is indicated by the reference numeral 600. The guard 600, similar to guard 100, is used for protecting plug-in devices. The guard 600 may be fitted to interior opposing portions of a computer housing 630. The guard 600 comprises a frame 605 having a through opening 606 through which plug-in devices can be inserted and removed from access ports included as part of the computer housing 630.

The guard 600 includes movable first and second arms 610, 615. The first and second arms 610, 615, may be operably connected to the frame 605, for example, via external hinges 660, 665. This location of the hinges 660, 665 means that the arms 610, 615 can fold outwardly, but not inwardly from a position that is perpendicular to the frame 605.

The first and second arms 610, 615 may each include a projecting portion, or stopper 620, 625, on the exterior side of the arms 610, 615. The stoppers 620, 625 engage the inner sides or edges of the computer housing 630 to ensure that the frame 605 is spaced a desired distance away from wall or face 632 of the computer housing 630.

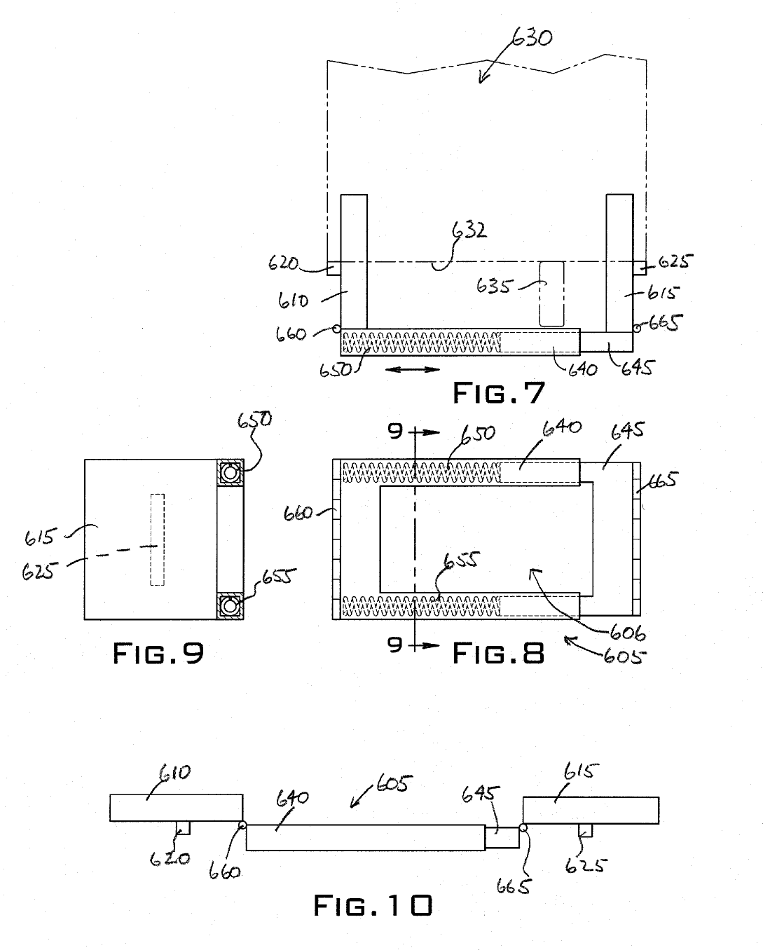

FIGS. 7-10 illustrate various parts of guard 600. FIG. 7 is a top plan view of guard 600 connected to the computer housing 630. Plug-in device 635 is connected to computer housing 630 via an access port. Similar to guard 100, the guard 600 also comprises first and second tubular members 640, 645 and two internal spring units 650, 655, both shown in a detailed front view of the guard 600 in FIG. 8. The second tubular member 645 is telescopically received into the first tubular member 640. The springs 650, 655 press against the ends of the second tubular member 645 and serve to bias the second tubular member 645 to the right as viewed in FIG. 7, i.e., to a position where the arms 610, 615 are apart from each other.

FIG. 8 also shows first and second hinges 660, 665 connecting the first and second arms 610, 615 to opposite sides of frame 605. The first and second hinges 660, 665 connect on the external sides of the guard 600 to allow the first and second arms 610, 615 to fold outwardly but not inwardly. FIG. 9 shows the second arm 615, stopper 625 (which is on the external side of second arm 615), and spring units 650, 655.

According to the embodiment shown in FIGS. 6-10, compression of the first and second tubular members 640, 645 against the bias of springs 650, 655 causes the first and second arms 610, 615, to move toward each other. Thus, as shown in FIG. 7, when the guard 600 is positioned over an access port of computer housing 630, the first and second tubular members 640, 645 may be compressed to retract the first and second arms 610, 615 inside the inner edges of computer housing 630. Releasing the first and second tubular members 640, 645, forces the first and second arms 610, 615 to bear against the inside of the computer housing 630. The guard 600 is retained in place on the housing 630 via spring tension. The stoppers 620, 625 engage the front wall or face 632 of the computer housing 630 to ensure that the frame 605 is spaced a desired distance away from the wall or face 632. That spacing, coupled with the size and shape of the opening 606, enables plug-in devices to be readily inserted into and removed from access ports in the computer housing 630 while protecting the devices from contact that might cause damage to the devices or the access ports.

In a manner similar to the guard 100, the guard 600 is collapsible to a relatively compact configuration for transport or storage. In order to accomplish this, the first and second arms 610, 615 of guard 600 fold outwardly as shown in FIG. 10.

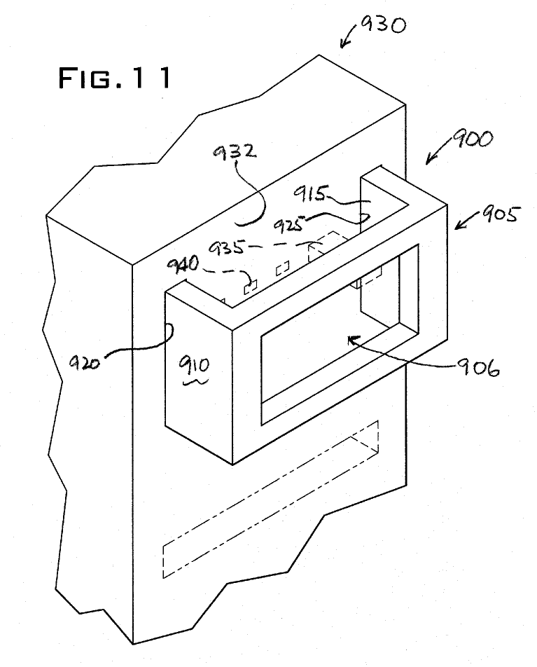

Referring to FIGS. 11-13, a perspective view of another embodiment of the present invention is shown and is indicated by the reference numeral 900. The guard 900 is similar to guards 100 and 600 and is used for protecting plug-in devices. The guards 100, 600 are removable devices that are not permanently fitted to a computer housing. The guard 900, in contrast, is permanently fitted to a computer housing 930 and is adapted for movement between an extended position where a plug-in device can be protected and a retracted position where the guard 900 is in contact with a wall or face 932 of the computer housing 930.

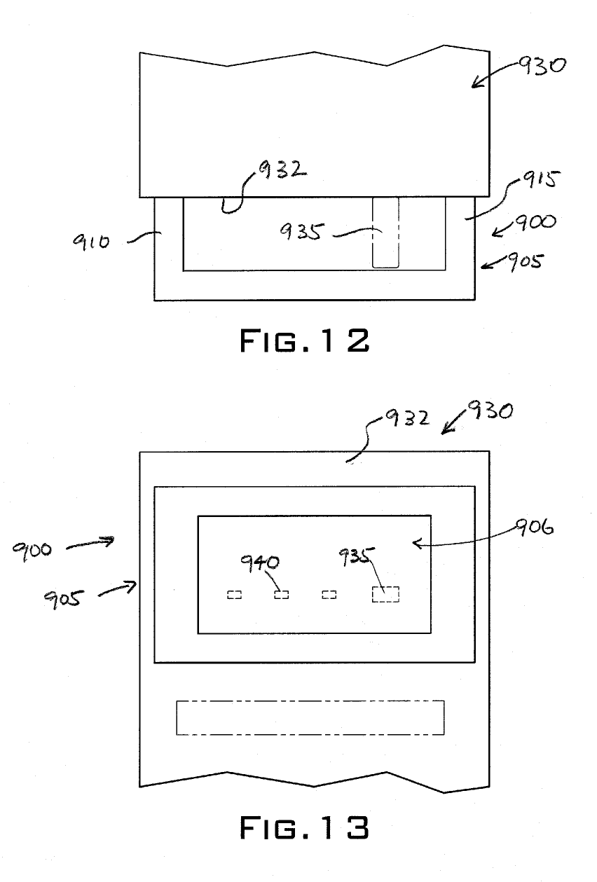

The guard 900 comprises a frame 905 having a through opening 906 and first and second arms 910, 915. The first and second arms 910, 915 are received in a telescoping manner by openings 920, 925 included as part of the computer housing 930. The length of the arms 910, 915 are selected such that the frame 905 is spaced a desired distance away from the wall or face 932 when the guard 900 is in the extended position. The first and second arms 910, 915 may be fitted into the openings 920, 925 without any type of actuating mechanism so as to require manual operation. Alternatively, the arms 910, 915 could be connected to springs and a ratchet-type release mechanism (not shown) contained within the computer housing 930. In that event, the guard 900 would be spring-biased to an open or extended position as is illustrated in FIGS. 11 and 12.

FIG. 12 is a top plan view of guard 900 connected to the computer housing 930. Plug-in device 935 is connected to computer housing 630 via an access port 940 (FIGS. 11 and 13). The frame 905 extends far enough away from the front wall or face 932 of the computer housing 930 that the plug-in device 935 will be adequately protected. As can be seen in FIG. 13, the opening 906 is large enough that the access ports 940 and the plug-in-device 935 can be accessed readily. When the guard 900 no longer is needed to protect a plug-in device 935, the guard can be easily pushed to a retracted position where the rear wall of the frame 905 engages the wall or face 932 of the computer housing 930.

It will be appreciated that the frames 105, 605, 905 can take different forms and that the openings 106, 606, 906 can be eliminated, if desired. In that event, the frames 105, 605, 905 can take the shape of an elongate, relatively thin bumper or guard rail that is positioned in proximity to any plug-in devices that may be inserted into access ports in the computer housing. Such proximity could be above or below the access ports. While such a bumper or guard rail may not provide the full extent of protection that is afforded by the frames 105, 605, 905, nevertheless such protection may be adequate for certain purposes. If a reduced-size bumper or guard rail is used, that could lessen the size of the supporting arms 110, 115, 601, 615, 910, 915 that are required to adequately support the bumper or guard rail. In turn, the overall size and expense of the device could be reduced.

Although the invention has been described in detail with reference to particular examples and embodiments, the examples and embodiments contained herein are merely illustrative and are not an exhaustive list. Variations and modifications of the present invention will readily occur to those skilled in the art. The present invention includes all such modifications and equivalents. The claims alone are intended to set forth the limits of the present invention.

What is claimed is:

1. A guard for protecting a plug-in device connected to an access port in a computer housing, comprising:
a bumper adapted to be positioned in proximity to the access port; and
a connection between the bumper and the housing, the connection causing the bumper to be spaced a distance away from the housing adequate to protect a plug-in device that is connected to the access port.

2. The guard of claim 1, wherein the bumper is in the form of a frame that has a through opening of a size and shape that permits a user to insert a plug-in device into the access port or to remove a plug-in device from the access port through the opening.

3. The guard of claim 1, wherein:
the bumper is generally straight and has opposed ends; and
the connection is in the form of first and second legs that are connected to the bumper at the opposed ends of the bumper, the first and second legs extending from the bumper at approximately a right angle.

4. The guard of claim 3, wherein the bumper includes first and second members that are movable relative to each other to permit the width of the bumper to be adjustable and for the first and second legs to contact a portion of the computer housing.

5. The guard of claim 4, wherein the first member of the bumper receives the second member of the bumper in a telescoping manner, one or more springs are disposed within the first member so at to be in contact with the first and second members, and the one or more springs bias the first and second members of the bumper toward each other.

6. The guard of claim 5, further comprising hinges that connect the first and second legs and the bumper for pivoting movement, the hinges positioned such that the first and second legs can be folded toward the bumper but not away from the bumper more than approximately a right angle, the first and second legs in use being biased into contact with the outside of the computer housing.

7. The guard of claim 6, further comprising projecting portions connected to and extending from the first and second legs, the projecting portions in use engaging the computer housing, the projecting portions being positioned relative to the bumper such that the bumper in use is positioned a desired distance from the computer housing.

8. The guard of claim 4, wherein the first member of the bumper receives the second member of the bumper in a telescoping manner, one or more springs are disposed within the first member so as to be in contact with each other, and the one or more springs bias the first and second members of the bumper away from each other.

9. The guard of claim 8, further comprising hinges that connect the first and second legs and the bumper for pivoting movement, the hinges positioned such that the first and second legs can be folded away from the bumper but not toward the bumper more than approximately a right angle, the first and second legs in use being biased into contact with inner portions of the computer housing.

10. The guard of claim 9, further comprising projecting portions connected to and extending from the first and second legs, the projecting portions in use engaging the computer housing, the projecting portions being positioned relative to the bumper such that the bumper in use is positioned a desired distance from the computer housing.

11. The guard of claim 3, wherein the computer housing includes a wall and first and second openings are formed in the wall to receive the first and second members in telescoping relationship, the first and second members being movable relative to the computer housing such that the bumper can be moved from a retracted position where the bumper is disposed adjacent the wall to an extended position where the bumper is spaced from the wall of the computer housing a desired distance adequate to protect a plug-in device inserted into an access port.

12. A guard for protecting a plug-in device connected to an access port in a computer housing, comprising:
a generally straight bumper having opposed ends adapted to be positioned in proximity to the access port, the bumper being in the form of a frame that has a through opening of a size and shape that permits a user to insert a plug-in device into the access port or to remove a plug-in device from the access port through the opening;
a connection between the bumper and the housing, the connection causing the bumper to be spaced a distance away from the housing adequate to protect a plug-in device that is connected to the access port, the connection being in the form of first and second legs that are connected to the bumper at the opposed ends of the bumper, the first and second legs extending from the bumper at approximately a right angle;
the bumper including first and second members that are movable relative to each other to permit the width of the bumper to be adjustable and for the first and second legs to contact a portion of the computer housing, the first member of the bumper receiving the second member of the bumper in a telescoping manner;
one or more springs disposed within the first member so as to be in contact with the first and second members, the one or more springs biasing the first and second members of the bumper toward each other;
hinges that connect the first and second legs and the bumper for pivoting movement, the hinges positioned such that the first and second legs can be folded toward the bumper but not away from the bumper more than approximately a right angle, the first and second legs in use being biased into contact with the outside of the computer housing; and
projecting portions connected to and extending from the first and second legs, the projecting portions in use engaging the computer housing, the projecting portions being positioned relative to the bumper such that the bumper in use is positioned a desired distance from the computer housing.

13. A method for protecting a plug-in device connected to an access port in a computer housing, comprising the steps of:
providing a bumper adapted to be positioned in proximity to the access port; and
connecting the bumper and the housing such that the bumper is spaced a distance away from the housing adequate to protect a plug-in device that is connected to the access port.

14. The method of claim 13, comprising the further steps of:
providing the bumper in the form of a frame that has a through opening of a size and shape that permits a user to insert a plug-in device into the access port or to remove a plug-in device from the access port through the opening; and
inserting a plug-in device into the access port through the opening in the frame.
